(19) United States
(12) Patent Application Publication
(10) Pub. No.: US 2013/0224675 A1
(43) Pub. Date: Aug. 29, 2013

(54) ELECTROSTATIC CHUCK DEVICE AND CONTROL METHOD THEREOF

(71) Applicant: Samsung Electronics Co., Ltd., (US)

(72) Inventor: Myoung Soo PARK, Seongnam-si (KR)

(73) Assignee: SAMSUNG ELECTRONICS CO., LTD., Suwon-Si (KR)

(21) Appl. No.: 13/778,328

(22) Filed: Feb. 27, 2013

(30) Foreign Application Priority Data
Feb. 28, 2012 (KR) 10-2012-0020438

(51) Int. Cl. F27D 5/00

(52) U.S. Cl. CPC F27D 5/00
USPC 432/253; 432/1

(57) ABSTRACT

An electrostatic chuck device includes a surface to support a substrate, an electrode to generate electrostatic force for the substrate, and a plurality of heaters to heat different regions of the surface. The plurality of heaters include a first heater to heat a first region to a first temperature, a second heater to heat a second region to a second temperature, and a third heater to heat a third region to a third temperature between the first and second temperatures. The second region is closer to a peripheral area of the surface than the first region, and the third region between the first and second regions.

### CROSS-REFERENCE TO RELATED APPLICATION

This application claims the benefit of Korean Patent Applications No. 2012-0020438, filed on Feb. 28, 2012 in the Korean Intellectual Property Office, the disclosure of which is incorporated herein by reference in its entirety.

### BACKGROUND

1. Field

The present disclosure relates to semiconductor devices.

2. Description of the Related Art

Manufacturing processes for semiconductors, Liquid Crystal Displays (LCDs), Light Emitting Diodes (LEDs), solar cells, and other devices may require fixing wafers, glass substrates, or the like. Some techniques use mechanical clamps or the application of pressure to fixed the position of wafers or glass substrates. Other techniques use an Electro Static Chuck (ESC) for this purpose.

One type of ESC generates electrostatic force via dielectric polarization depending on a potential difference between a wafer or glass substrate and a dielectric. Using this force, an ESC can fix a wafer or glass substrate without coming into contact with the wafer or glass substrate.

Another type of ESC generates electrostatic adhesion force, such as Johnson-Rabeck force or Coulomb force, by applying voltage to an electrostatic adhesion electrode.

Another type of ESC electrostatically fixes the position of a wafer or glass substrate using a heater which maintains the wafer or glass substrate at a constant temperature. While these chucks have proven adequate for some applications, they still have drawbacks.

### SUMMARY

In accordance with one example embodiment, an electrostatic chuck device is provided having an enhanced temperature control function.

In accordance with an example embodiment, an electrostatic chuck device includes an electrode to generate electrostatic force required to fix a substrate, and a plurality of heaters to heat the substrate fixed by the electrostatic force, wherein at least one of the plurality of heaters is a buffer heater to restrict diffusion of heat generated between peripheral heaters. A heating region of the buffer heater may have a width of about 20 mm or less, and a temperature of the buffer heater may have a value between temperatures of the heaters close to the buffer heater.

The electrostatic chuck device further includes a plurality of power source units to supply power to the plurality of heaters respectively, and a controller to control the plurality of power source units in order to adjust the power supplied to each of the plurality of heaters.

The controller may control the power source units to adjust power to be supplied to the buffer heater, to assist the buffer heater in restricting diffusion of heat generated between the peripheral heaters.

The controller may control a power source unit to supply power to the buffer heater such that a temperature of the buffer heater has a value between temperatures of the heaters close to the buffer heater.

The controller may control each of the plurality of power source units to drive the plurality of heaters based on a temperature profile if the temperature profile for heating of the substrate is determined, and the controller may adjust power to be supplied to a heater corresponding to a boundary of the temperature profile as a temperature change region, to assist the heater in restricting heat diffusion between the peripheral heaters.

The controller may adjust power to be supplied to the heater corresponding to the boundary such that a temperature of the boundary heater has a value between temperatures of the heaters close to the boundary heater.

In accordance with another example embodiment, a control method of an electrostatic chuck device includes determining a temperature profile require for heating of a substrate, adjusting power applied to a plurality of heaters to drive the heaters based on the determined temperature profile, and adjusting power supplied to a heater corresponding to a boundary of the temperature profile as a temperature change region, to assist the heater in restricting heat diffusion between peripheral heaters thereof.

In accordance with another example embodiment, an electrostatic chuck device includes an electrode to generate electrostatic force required to fix a substrate, and a plurality of heaters to heat the substrate fixed by the electrostatic force, wherein at least one of the plurality of heaters is a buffer heater to restrict diffusion of heat generated between peripheral heaters. A heating region of the buffer heater may have a width of about 20 mm or less, and a temperature of the buffer heater may have a value between temperatures of the heaters close to the buffer heater.

The electrostatic chuck device may further include a plurality of power source units to supply power to the plurality of heaters respectively, and a controller to control the plurality of power source units in order to adjust the power supplied to each of the plurality of heaters.

The controller may control the power source units to adjust power to be supplied to the buffer heater, to assist the buffer heater in restricting diffusion of heat generated between the peripheral heaters.

The controller may control a power source unit to supply power to the buffer heater such that a temperature of the buffer heater has a value between temperatures of the heaters close to the buffer heater.

The controller may control each of the plurality of power source units to drive the plurality of heaters based on a temperature profile if the temperature profile for heating of the substrate is determined, and the controller may adjust power to be supplied to a heater corresponding to a boundary of the temperature profile as a temperature change region, to assist the heater in restricting heat diffusion between the peripheral heaters.

The controller may adjust power to be supplied to the heater corresponding to the boundary such that a temperature of the boundary heater has a value between temperatures of the heaters close to the boundary heater.

In accordance with another example embodiment, a control method of an electrostatic chuck device includes determining a temperature profile require for heating of a substrate, adjusting power applied to a plurality of heaters to drive the heaters based on the determined temperature profile, and adjusting power supplied to a heater corresponding to a boundary of the temperature profile as a temperature change region, to assist the heater in restricting heat diffusion between peripheral heaters thereof.

In accordance with another example embodiment, an electrostatic chuck device comprises a surface configured to support a substrate, an electrode configured to generate electrostatic force for the substrate, and a plurality of heaters configured to heat different regions of the surface. The plurality of heaters include a first heater configured to heat a first region to a first temperature, a second heater configured to heat a second region to a second temperature, and a third heater configured to heat a third region to a third temperature between the first and second temperatures. The second region is closer to a peripheral area of the surface than the first region, and the third region between the first and second regions.

The third region may have a width less than a width of at least one of the first region or the second region, or the third region may have a width less than a width of the first region and the second region.

The first region may be maintained substantially at the first temperature based on the third temperature of the third region.

The third temperature may be set based on an average of the first and second temperatures. The third temperature of the third region may allow a temperature distribution of a slanted slope to form between the first temperature and the second temperature.

The device may further include a plurality of power sources configured to supply power to the plurality of heaters respectively; and a controller configured to control the plurality of power sources in order to adjust the power supplied to each of the plurality of heaters. The controller may control the power sources to adjust power to be supplied to the third heater to allow the third heater to reach the third temperature.

The controller may control the plurality of power sources to drive the plurality of heaters based on a temperature profile, and may adjust power to be supplied to the third heater corresponding to a boundary of the temperature profile corresponding to a temperature change region.

The plurality of heaters may include a fourth heater to heat a fourth region between the second region and the first region to a fourth temperature, and the controller adjusts power to the third heater such that the third temperature is greater than the second temperature and the fourth.

In accordance with another example embodiment, an electrostatic chuck device includes a surface configured to support a substrate and a plurality of heaters configured to heat different regions of the surface to achieve a temperature distribution. The plurality of heaters include a first heater configured to heat a first region to a first temperature, a second heater configured to heat a second region to a second temperature, and a third heater configured to generate a plurality of temperatures in the temperature distribution corresponding to a third region. The third region is between the first and second regions and the plurality of temperatures in the temperature distribution corresponding to the third region changing at a rate.

The plurality of temperatures in the temperature distribution may correspond to the third region decrease at the rate from the first temperature to the second temperature. The rate may correspond to a slanted slope in the temperature distribution. Also, the second region may be closer to a peripheral area of the surface than the first region.

The third heater may be set to a same temperature to generate the plurality of temperatures in the temperature distribution corresponding to a third region. The third region may have a width different from a width of at least one of the first region or the second region. The third region may have a width different from widths of the first region and the second region. The third region may have a width less than widths of the first region and the second region.

The first region may be maintained at substantially the first temperature based on the plurality of temperatures in the temperature distribution corresponding to the third region. The first region may be a central region of the surface.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 shows an example embodiment of an electrostatic chuck;

FIGS. 2A and 2B show heating regions of electrostatic chucks that have different numbers of heaters;

FIG. 3 shows an example of a temperature profile for the chuck;

FIG. 4 shows an example of a temperature distribution of a substrate when heated based on a temperature profile in FIG. 3;

FIG. 5 shows a temperature distribution having an intermediate heating zone;

FIG. 6 shows a temperature distribution graph; and

FIG. 7 shows operations included in an embodiment of a method performed using an electrostatic chuck.

### DETAILED DESCRIPTION OF THE EXAMPLE EMBODIMENTS

The present disclosure will now be described more fully hereinafter with reference to the accompanying drawings, in which various example embodiments are shown. The examples may, however, be embodied in different forms and should not be construed as limited to the embodiments set forth herein. Rather, these embodiments are provided so that this disclosure will be more thorough and complete, and will fully convey the scope of the disclosure to those skilled in the art. The same reference numbers indicate the same components throughout the specification. In the attached figures, the thickness of layers and regions may have been exaggerated for clarity.

It will be understood that when an element or layer is referred to as being “connected to,” or “coupled to” another element or layer, it can be directly connected to or coupled to another element or layer or intervening elements or layers may be present. In contrast, when an element is referred to as being “directly connected to” or “directly coupled to” another element or layer, there are no intervening elements or layers present. Like numbers refer to like elements throughout. As used herein, the term “and/or” includes any and all combinations of one or more of the associated listed items.

It will also be understood that when a layer is referred to as being “on” another layer or substrate, it can be directly on the other layer or substrate, or intervening layers may also be present. In contrast, when an element is referred to as being “directly on” another element, there are no intervening elements present.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present disclosure.

The use of the terms “a” and “an” and “the” and similar referents in the disclosure (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Unless defined otherwise, all technical and scientific terms used herein have the same meaning as commonly understood by one of ordinary skill in the art to which this disclosure belongs. It is noted that the use of any and all examples provided herein is intended merely to better illuminate the various embodiments and is not a limitation on the scope of the disclosure unless otherwise specified. Further, unless defined otherwise, all terms defined in generally used dictionaries should not be overly interpreted.

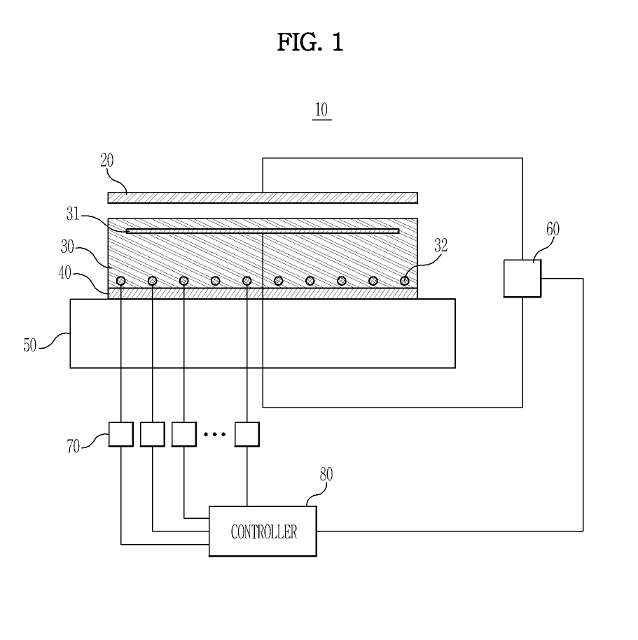

FIG. 1 shows an embodiment of an electrostatic chuck apparatus 10 that includes a base 50, an electrostatic chuck 30, and an adhesive layer 40. The electrostatic chuck includes an electrode 31 to generate electrostatic force required to fix a substrate 20 and a heater 32 to heat the substrate 20. The adhesive layer 40 adheres the base 50 to the electrostatic chuck 30.

The base 50 may be formed of a material that includes a metal such as an aluminum alloy, stainless steel, or molybdenum. The base 50 may serve as an RF power electrode to generate plasma for processing of the substrate 20. During processing of the substrate 20 using plasma, the interior of a chamber is heated to a high temperature.

However, when the substrate 20 is exposed to the high temperature for a long time, this may cause damage to the substrate 20. Therefore, lowering a temperature of the substrate 20 may be performed. To this end, a feed path may be formed in the base 50 to allow cooling gas (e.g., Ar, and He) to be fed into a space for temperature control of the substrate 20 through the feed path.

The adhesive layer 40 may be formed on a front surface of the base 50 to attach the base to the electrostatic chuck 30 in a manner to be described. The adhesive layer 40 may be formed, for example, of an organic adhesive such as epoxy adhesive or silicone.

The electrostatic chuck 30 may be formed of a dielectric material that may include an inorganic material such as BeO, SiO2, Ta2O5, ZrO2CaO, MgO, TiO2, and BaTiO3, a ceramic material such as aluminum oxide called alumina, a nitride-based compound such as MN, TiN, BN and SiN4, or a silicide such as MoSi2. The dielectric material may also include a polymer such as polytetrafluoroethylene (PTFE), one or more thermosetting resins, a polyimide, and/or one or more urea resins.

The electrode 31 provided in the electrostatic chuck 30 generates an electrostatic force sufficient to fix the substrate 20. The electrode 31 may be formed of a conductive material such as tungsten (W) or molybdenum (Mo). Also, the electrostatic chuck 30 may be a unipolar type including a single electrode or a bipolar type including two electrodes.

The electrostatic chuck device 10 also includes or is coupled to a first power source unit 60 that supplies current to electrode 31 to generate electrostatic force. The current may, for example, be direct current. Power from the first power source unit 60 may be adjusted under control of a controller 80.

In one embodiment, the electrostatic chuck 30 includes a plurality of heaters 32 to heat the substrate 20. The heaters 32 may be, for example, resistive heaters formed of nichrome wires. The plurality of heaters 32 may be independent concentric elements.

The electrostatic chuck device 10 may also include a plurality of second power source units 70 that supply alternating current to respective ones of the heaters 32 to generate heat. Power supplied by the second power source units 70 may be adjusted under control of the controller 80.

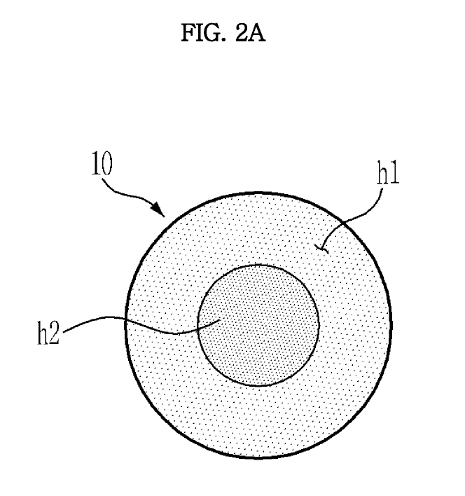

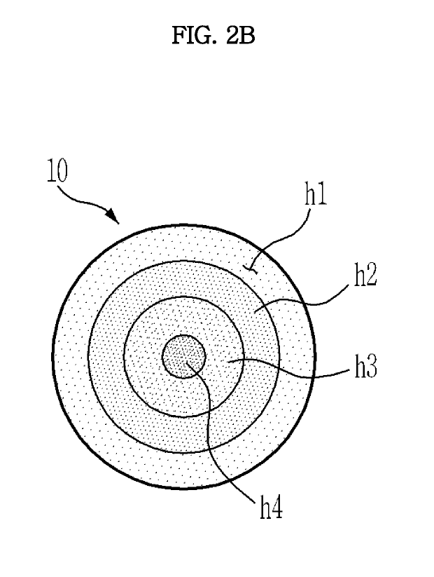

FIGS. 2A and 2B show heating regions for different embodiments of the chuck. In these exemplary embodiments, the heating regions are heated a corresponding number of heaters 32.

FIG. 2A shows a top view of the chuck having two heating regions h1 and h2 which are heated by two heaters 32, respectively, when the electrostatic chuck 30 includes the two heaters. FIG. 2B shows top view of the chuck having four heating zones h1, h2, h3, and h4 which are heated by respective ones of four heaters 32 when the electrostatic chuck 30 includes the four heaters 32.

The temperatures of the heating regions may be adjusted by controlling power supplied to the heaters 32. For example, according to one embodiment, the heating regions may be controlled by respective ones of the heaters to have different temperatures.

In a semiconductor device fabrication process, a temperature of the substrate 20 is one factor which has an effect on process results and yield. These process results include process uniformity. One approach for achieving process uniformity involves controlling temperatures of the heaters 32 based on a temperature profile calculated to reduce non-uniformity. When implementing such an approach, it may be difficult to form a correct temperature profile for this purpose because of, for example, diffusion of heat generated from a constituent ceramic material of the electrostatic chuck 30.

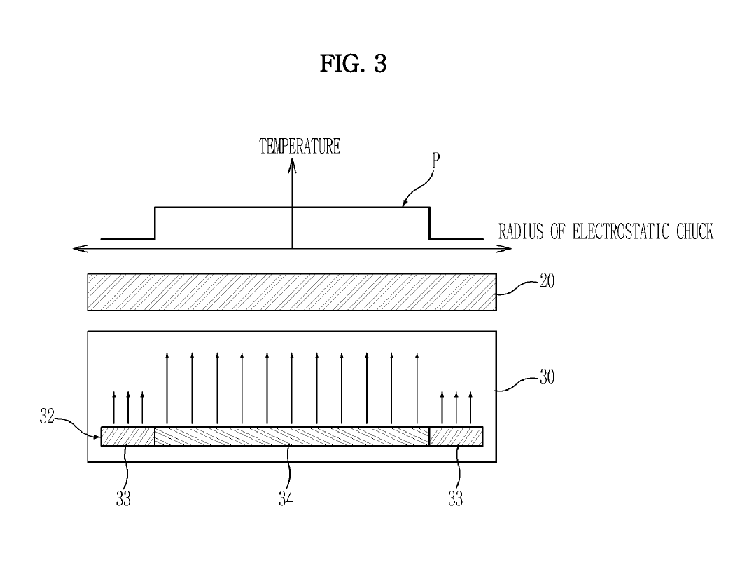

FIG. 3 shows one temperature profile p that may be used to control the heaters of electrostatic chuck 30. This temperature profile is calculated to reduce process non-uniformity. In this example, two heaters 32 for generating a corresponding number of heating regions are shown. In other embodiments, the chuck may include a different number of heaters to generate a same or different number of heating regions. Also, in other embodiments, the chuck may be controlled using a different temperature profile and/or the heating regions may have different widths that those shown in the example of FIG. 3.

In FIG. 3, temperature profile p is calculated such that a peripheral region has a low temperature and a center region has a high temperature. Thus, the temperature of a center heating region 34 is controlled to be higher than the temperature of a peripheral heating region 33 based on temperature profile p. (The lengths of the arrows represent a quantity of heat generated for the heating region).

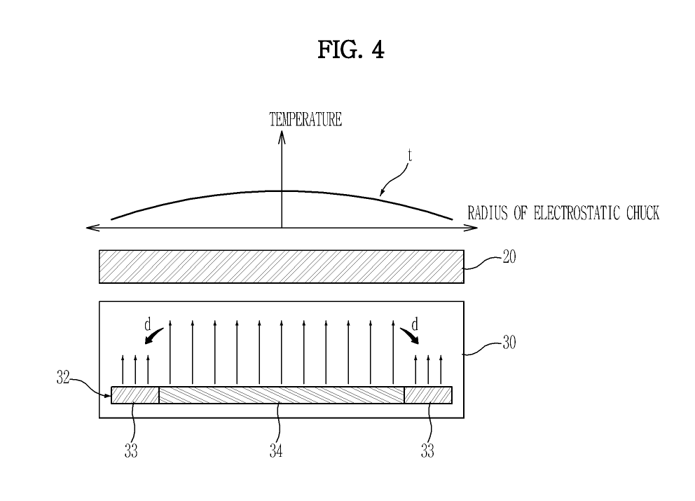

FIG. 4 shows a temperature distribution t of substrate 20 when the heaters 32 are controlled based on the temperature profile p. As shown, temperature distribution t deviates from temperature profile p.

More specifically, as represented by arrows d, heat at center region 34 spreads to peripheral region 33 due to heat diffusion of ceramics. This heat diffusion d causes temperature distribution t to deviate from temperature profile p, and as a result the center region may fluctuate or otherwise exhibit a non-constant temperature distribution. That is, the temperature of the center region may decrease toward the peripheral region, as illustratively shown by the curve in distribution t. When temperature distribution t deviates from temperature profile p, process non-uniformity may occur.

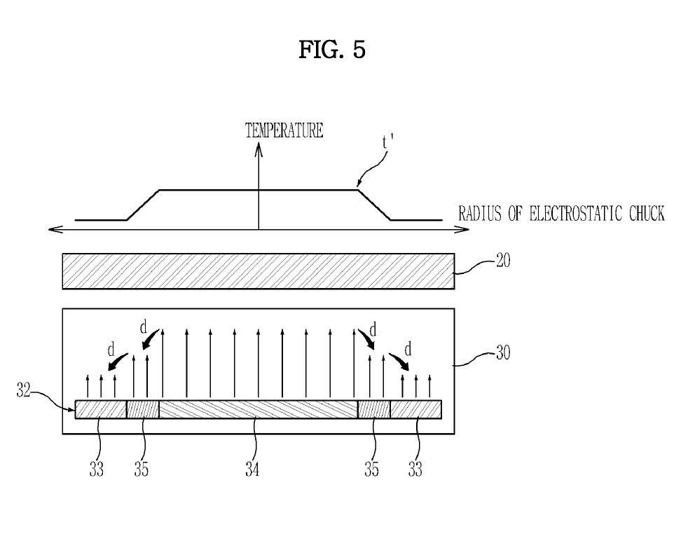

FIG. 5 shows another temperature distribution t′ of the electrostatic chuck 30. In this embodiment, a buffer region 35 is provided between heating regions 33 and 34 of FIG. 3 to reduce the effects of heat diffusion d. The buffer region 35 may be heated by one or more corresponding heaters 32 (hereinafter referred to as a buffer heater). Using temperature profile t′, the buffer region 35 allows for a stepwise heat diffusion d to take place, which thereby allows temperature distribution t′ to deviate less from temperature profile p. This may result in improved process uniformity.

In accordance with one embodiment, buffer region 35 is controlled to have a temperature value between a temperature of the center heating region 34 and a temperature of the peripheral heating region 33, in order to reduce the rate of heat diffusion between the center and peripheral heating regions.

This may be accomplished by having controller 80 control the second power source unit 70 that supplies power to the buffer heater corresponding to the buffer region 35, such that a temperature of the buffer region 35 heated by the buffer heater has a value between temperatures of the heating regions 33 and 34.

In accordance with one embodiment, the temperature of buffer region 35 may be calculated based on an arithmetic average of the temperatures of peripheral heating region 33 and center heating region 34. In other embodiments, the temperature of the buffer region may be determined differently.

As shown in FIG. 5, the temperature of buffer region 35 may allow for the temperature distribution corresponding to region 35 to have a given slope between constant temperatures in distribution t′ at the center heating region 34 and the peripheral region 33. As a result of this slope, temperature distribution t′ may deviate less from temperature profile p.

The chuck shown in FIG. 5 has one buffer heating region. In other embodiments, a plurality of buffer heating regions may be included to provide a more gradual transition of the temperature distribution from the center region to the peripheral region using, for example, smaller steps. Such an embodiment may be considered to further reduce deviation between the temperature distribution of the chuck and temperature profile p.

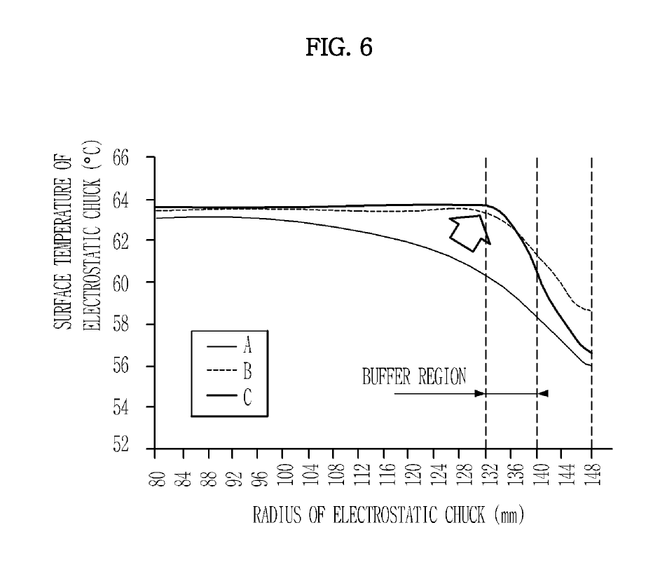

FIG. 6 shows an experimental graph generated for an electrostatic chuck 30 having at least one buffer heating region. In FIG. 6, curve A represents a temperature distribution in a case in which the buffer region 35 is not present, and the curves B and C respectively represent temperature distributions in a case in which the buffer region 35 illustrated in FIG. 5 is present.

Considering the temperature distribution represented by the curve A, in the case in which the buffer region 35 is not present, the region corresponding to center heating region 34 gradually decreases in temperature as a result of heat diffusion d taking place. This effect prevents the temperature distribution in the center heating region of Curve A from maintaining a constant temperature in accordance with temperature profile p.

In contrast, the temperature distribution represented by curves B and C in which the buffer region 35 is present maintains a substantially constant temperature in center heating region 34 before buffer region 35. This is because the buffer heating region reduces heat diffusion and therefore allows the temperature in the center heating region to maintain a substantially constant temperature corresponding to temperature profile p.

In accordance with one exemplary embodiment, the width of buffer region 35 may be set to 20 mm or less and the temperature of buffer region 35 may be controlled by controller 80 controlling a corresponding one of the second power source units 70.

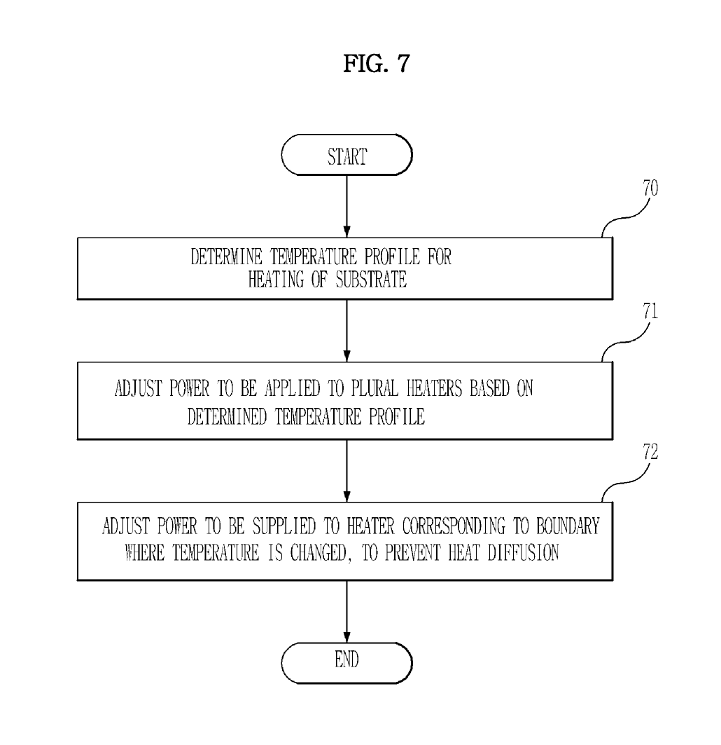

FIG. 7 shows operations included in one embodiment of a method for controlling an electrostatic chuck device. The method is described as controlling electrostatic chuck device 10 in FIG. 1. However, in other embodiments, the method may be applied to control another type of chuck device.

Initially, a temperature profile p for heating of substrate 20 is determined (70). The temperature profile p may be determined to compensate for non-uniformity that may occur by various factors depending on facilities or processes, in order to enhance process uniformity. In another embodiment, the temperature profile may be determined produce another result or performance of the chuck.

Once temperature profile p is determined, alternating current applied to the plurality of heaters 32 is adjusted based on the determined temperature profile p (71). The plurality of second power source units 70 is controlled to respectively adjust alternating current supplied to heaters 32. The respective heating regions h of the church are then heated by the plurality of heaters 32 toward reaching temperatures based on temperature profile p.

In the temperature profile p, the power of heater 32 that corresponds to a boundary that is a temperature change region is adjusted to restrict heat diffusion d that occurs between the peripheral heaters 32 (72). This boundary may correspond to buffer region 35 between heating regions 33 and 34 in FIG. 3. The heating produced in this buffer region reduces heat diffusion d from the center heating region. The buffer region 35 is heated by the corresponding heater 32, i.e. the buffer heater.

More specifically, the buffer region 35 may be controlled to have a value between a temperature of the center heating region 34 and a temperature of the peripheral heating region 33, in order to restrict heat diffusion d between the center heating region 34 and the peripheral heating region 33.

That is, the controller 80 may control the second power source unit 70 that supplies power to the buffer heater corresponding to the buffer region 35, such that a temperature of the buffer region 35 heated by the buffer heater has a value between temperatures of the heating regions 33 and 34.

Although the temperature of the buffer region 35 may be simply calculated as an arithmetic average of the temperatures of the center and peripheral heating regions, a different or optimum value for temperature profile p may be calculated.

As is apparent from the above description, an electrostatic chuck device according to one or more embodiments described herein may control a surface temperature of a substrate to more closely correspond to a desired temperature profile, which may result in enhanced process uniformity of the substrate.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. An electrostatic chuck device comprising:
an electrode configured to generate electrostatic force required to fix a substrate; and
a plurality of heaters configured to heat the substrate fixed by the electrostatic force, wherein at least one of the plurality of heaters is a buffer heater configured to restrict diffusion of heat generated between peripheral heaters.

2. The device according to claim 1, wherein a heating region of the buffer heater has a width of about 20 mm or less.

3. The device according to claim 1, wherein the buffer heater is configured to have a temperature of a value between temperatures of the heaters close to the buffer heater.

4. The device according to claim 1, further comprising:
a plurality of power sources configured to supply power to the plurality of heaters respectively; and
a controller configured to control the plurality of power sources in order to adjust the power supplied to each of the plurality of heaters.

5. The device according to claim 4, wherein the controller is configured to control the power sources to adjust power to be supplied to the buffer heater, to assist the buffer heater in restricting diffusion of heat generated between the peripheral heaters.

6. The device according to claim 5, wherein the controller is configured to control a power source to supply power to the buffer heater such that a temperature of the buffer heater has a value between temperatures of the heaters close to the buffer heater.

7. The device according to claim 4, wherein the controller is configured to
control each of the plurality of power sources to drive the plurality of heaters based on a temperature profile if the temperature profile is determined, and
adjust power to be supplied to at least one of the plurality of heaters corresponding to a boundary of the temperature profile as a temperature change region, to assist the heater in restricting heat diffusion between the peripheral heaters.

8. The device according to claim 7, wherein the controller is configured to adjust power to be supplied to the heater corresponding to the boundary such that a temperature of the boundary heater has a value between temperatures of the heaters close to the boundary heater.

9. An electrostatic chuck device comprising:
a surface configured to support a substrate; and
a plurality of heaters configured to heat different regions of the surface to achieve a temperature distribution, the plurality of heaters including
a first heater configured to heat a first region to a first temperature,
a second heater configured to heat a second region to a second temperature, and
a third heater configured to generate a plurality of temperatures in the temperature distribution corresponding to a third region, the third region between the first and second regions.

10. The device of claim 9, wherein the plurality of temperatures in the temperature distribution corresponding to the third region decrease at the rate from the first temperature to the second temperature.

11. The device of claim 9, wherein the rate corresponds to a slanted slope in the temperature distribution.

12. The device of claim 9, wherein the second region is closer to a peripheral area of the surface than the first region.

13. The device of claim 9, wherein the third heater is set to a same temperature to generate the plurality of temperatures in the temperature distribution corresponding to a third region.

14. The device of claim 9, wherein the third region has a width different from a width of at least one of the first region or the second region.

15. The device of claim 9, wherein the third region has a width different from widths of the first region and the second region.

16. The device of claim 9, wherein the third region has a width less than widths of the first region and the second region.

17. The device of claim 9, wherein the first region is maintained at substantially the first temperature based on the plurality of temperatures in the temperature distribution corresponding to the third region.

18. The device of claim 9, wherein the first region is a central region of the surface.

19. A control method of an electrostatic chuck device comprising:
determining a temperature profile require for heating of a substrate;
adjusting power applied to a plurality of heaters to drive the heaters based on the determined temperature profile; and
adjusting power supplied to a heater corresponding to a boundary of the temperature profile as a temperature change region, to assist the heater in restricting heat diffusion between peripheral heaters thereof.
